(19) United States
(12) Patent Application Publication
(10) Pub. No.: US 2008/0043063 A1
(43) Pub. Date: Feb. 21, 2008

(54) Actuator Chip for Inkjet Printhead with Temperature Sense Resistors Having Current, Single-Point Output

(76) Inventors: Steven Wayne Bergstedt, Winchester, KY (US); Carson Allan Fisher, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/427,174

(22) Filed: Jun. 28, 2006

(51) Int. Cl. B41J 2/05

(52) U.S. Cl. 347/62

(57) ABSTRACT

An inkjet printhead includes an actuator chip for delivering ink from the printhead. The actuator chip has a plurality of bond pads for electrically connecting to a controller of an external device. A plurality of temperature sense resistors (TSRs) of the actuator chip each has an output provided as a current proportional to temperature of nearby vicinities and such connect to only a single one of the bond pads. On-chip circuitry also scales the outputs on the actuator chip which avoid scaling at the controller of the external device. Representative arrangements of the TSRs include transistor drivers in or out of feedback loop circuits. Attendant circuitry representatively includes switching logic, current mirrors, and amplifiers. Functionality of the circuitry includes actuator chip temperature averaging, actuator chip temperature zones, current scaling and gain, and point source TSRs. Inkjet printers and other external devices are also disclosed.

### FIELD OF THE INVENTION

The present invention relates to inkjet printheads. In particular, it relates to an actuator chip having one or more temperature sense resistors (TSRs). In one aspect, TSRs indicate temperature in the form of output current. In another, TSRs provide single point outputs. In still other aspects, various circuit designs, chip temperature averaging, chip temperature zones, current scaling and gain, and point source TSRs are contemplated.

### BACKGROUND OF THE INVENTION

The art of printing images with inkjet technology is well known. In general, an image is produced by ejecting ink drops from a printhead at precise moments so they impact a print medium at a desired location. The quality and consistency of the printing, however, is dependent on a number of factors, such as ink temperature.

In this regard, the viscosity of the ink varies with temperature and causes ink drops with a lower temperature to eject with a drop mass and velocity different than an ink drop with a higher temperature. Because the mass and velocity implicate where the drops are located on the print medium, if the temperature of the ink is not maintained at all or not maintained well, then the velocity (and mass) deviate from expected calculations and drops misdirect upon firing or are malformed before firing. Both result in drop placement errors which causes poor or inconsistent print quality.

To overcome this, certain prior art devices measure temperature in printheads and undertake activities to increase or decrease the temperature, as the case may be. Typically, one or more temperature sense resistors (TSRs) are employed to measure die or chip temperature. In turn, the die temperature is correlated to the ink temperature. Also, some prior art printheads have multiple colors per a single die and therefore there are multiple ink actuator array regions having multiple corresponding temperature regions. The regions vary in temperature due to a variety of reasons, such as printing activity or distance away from the die edge, to name a few.

In general, temperature measurements use the temperature-dependent resistance of the TSR and an external resistor to create a voltage that is related to temperature. In one instance, the resistance of the TSRs relates linearly to the die temperature and the slope is approximately 2000-3000 parts per million (ppm) per degree Celsius. From there, the obtained voltage is scaled up by an external gain amplifier. To the extent multiple TSRs are used, the different TSR terminals are combined with a passive multiplexer, in turn, representatively composed of a large 500 micron, wide NMOS transistor device for each of the TSRs. On the one hand, the device must be large enough to minimize its resistance, since the on-resistance of NMOS transistors has a different temperature coefficient than typical TSRs and causes large errors to the extent its effect is not minimized. On the other, it cannot be so large that it consumes valuable die real estate.

Ultimately, the foregoing designs are problematic for at least the following: they are too sensitive to noise; they require too large a die area; and they require two input/output (I/O) terminals (corresponding to both ends of the TSR) to make a measurement. For example, a typical output voltage delta that must be sensed at the TSR terminals is approximately 1.6 millivolts per degree Celsius. Amplifiers external to the chip, however, scale this upward tenfold to 16 millivolts per degree Celsius, for purposes of reading, but correspondingly they also scale up the noise that is present at the TSR terminals. In this regard, representative noise comes from a variety of sources, such as the signals related to the many ink actuator firing events. While filtering is typically applied to minimize noise, it causes a settling constraint which regularly results in a latency effect between a temperature change and the ability to sense a voltage change.

Moreover, a system function of the TSR is to average the die temperature near its local ink actuator array. To do this, however, the TSR must be as long as the array itself. By modern standards, this amounts to distances of about one half inch. As printhead chip dimensions change to larger printing swaths, one-inch for example, large TSRs create other problems. That is, large TSRs introduce more noise, not less, into output voltages. Also, average temperatures may not be as important with newer chip designs because local hot spots may develop and more sensing elements may be required, including two I/O pins per each TSR.

Accordingly, the inkjet printhead arts desire ongoing TSR technology despite a trend toward variously sized chip configurations. Further, a need exists to keep the technology as small as possible, to eliminate high I/O terminal counts, and minimize or eliminate noise attendant with TSR readings. Naturally, any improvements should further contemplate good engineering practices, such as relative inexpensiveness, low complexity, ease of manufacturing, etc.

### SUMMARY OF THE INVENTION

The above-mentioned and other problems can be solved by applying the principles and teachings associated with the hereinafter described inkjet printhead actuator chip having a single, current output for one or more TSRs.

In one aspect, an inkjet printhead includes an actuator chip for delivering ink from the printhead. The actuator chip has multiple I/O terminals, in the form of bond pads, and such electrically connect the printhead to a controller of an external device, such as an inkjet printer. A plurality of temperature sense resistors (TSRs) of the actuator chip each has an output provided as a current, not voltage, proportional to temperature of nearby vicinities of the chip. The output also connects to only a single one of the bond pads. In this manner, chip I/O count over the prior art is improved. Circuitry also scales the outputs of the TSRs directly on the actuator chip which avoids scaling at the controller of the external device. Noise is minimized because scaling need not occur off the chip, as was done with the prior art.

In representative arrangements, the TSRs and various transistor drivers exist in or out of feedback loop circuits upon selection via switches. Other circuitry includes, but is not limited to, switching logic, current mirrors, and amplifiers. Functionally, the circuitry includes actuator chip temperature averaging, actuator chip temperature zones, current scaling and gain, and point source TSRs.

In still other aspects of the invention, inkjet printheads, containing actuator chips, and printers or other external, devices, containing printheads, are disclosed.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIG. 1 is a perspective view in accordance with the teachings of the present invention of an inkjet printhead and actuator chip having temperature sense resistor(s) with a current, single-point, output;

FIG. 2 is a perspective view in accordance with the teachings of the present invention of an exemplary printer for use with the inkjet printhead and actuator chip of FIG. 1;

FIG. 3 is a diagrammatic circuit in accordance with the teachings of the present invention of a representative temperature sense resistor of an actuator chip;

FIG. 4 is a diagrammatic circuit in accordance with the teachings of the present invention of a representative temperature sense resistor with a current, single-point output;

FIG. 5 is a graph in accordance with the teachings of the present invention of a representative output current versus temperature of an actuator chip;

FIG. 6 is a diagrammatic circuit in accordance with the teachings of the present invention of representative multiple temperature sense resistors of an actuator chip;

FIG. 7 is a diagrammatic circuit in accordance with the teachings of the present invention of a representative temperature sense resistor of an actuator chip having control circuitry;

FIG. 8 is a diagrammatic circuit in accordance with the teachings of the present invention of representative multiple temperature sense resistors of an actuator chip for averaging temperature;

FIGS. 9A-9C are diagrammatic views in accordance with the teachings of the present invention of a representative actuator chip showing temperature sense resistor placement and single-point output;

FIG. 10 is a diagrammatic circuit in accordance with the teachings of the present invention of representative temperature sense resistors of an actuator chip with proposed component values; and

FIG. 11 is a diagrammatic view in accordance with the teachings of the present invention of an alternate representative actuator chip with temperature sense resistors as a point source and including a current, single-point output.

### DETAILED DESCRIPTION OF EXEMPLARY EMBODIMENTS

In the following detailed description of exemplary embodiments, reference is made to the accompanying drawings (with like numerals representing like elements) that form a part hereof, and in which is shown by way of illustration, specific embodiments in which the invention may be practiced. These embodiments are described in sufficient detail to enable those skilled in the art to practice the invention, and it is to be understood that other embodiments may be utilized, and that process, electrical, mechanical or other changes may be made without departing from the scope of the present invention. Appreciating the actuator chip of the invention typifies a wafer or substrate, such contemplates ceramic and silicon substrates utilizing, or not, silicon-on-sapphire (SOS) technology, silicon-on-insulator (SOI) technology, thin film transistor (TFT) technology, doped and undoped semiconductors, epitaxial layers of silicon supported by a base semiconductor structure, as well as other structures well known to one skilled in the art. The following detailed description is, therefore, not to be taken in a limiting sense, and the scope of the present invention is defined only by the appended claims and their equivalents. An inkjet printhead actuator chip having one or more TSRs with a current-based, single-point output is hereinafter described.

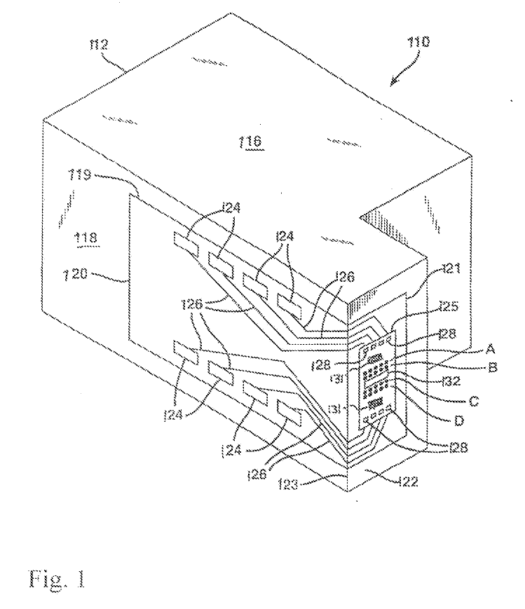

In FIG. 1, an inkjet printhead is shown generally as 110. It includes an actuator chip 125 having one or more TSRs 131 that connect to single one of the many I/O terminals expressed representatively as bond pads 128. In form, the output also embodies a current proportional to temperature in a vicinity of the respective TSRs. Circuitry and other details are described below with reference to other figures.

The printhead has a housing 112 with a shape that depends mostly upon the shape of the external device, e.g., printer, fax machine, scanner, copier, photo-printer, plotter, all-in-one, etc., that contains and uses it. The housing has at least one internal compartment 116 for holding an initial or refutable supply of ink. In one embodiment, the compartment contemplates a single chamber holding a supply of black, cyan, magenta or yellow ink. In other embodiments, it contemplates multiple chambers containing multiple different or same colored inks. Its compartment may also exist locally integrated within a housing 112 (as shown) or separable from the housing 112 and/or printhead 110 and connect via tubes or other conduits, for example.

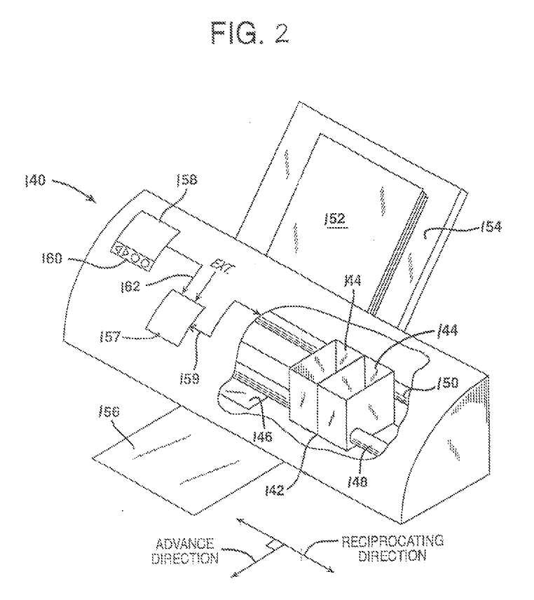

At one surface 118 of the housing 112, a portion 119 of a flexible circuit, especially a tape automated bond (TAB) circuit 120, is adhered. At 121, another portion is adhered to surface 122. Electrically, the TAB circuit 120 supports a plurality of input/output (I/O) connectors 124 for connecting an actuator chip 125, such as a heater chip, to the external device during use. Pluralities of electrical conductors 126 exist on the TAB circuit to connect and short the I/O connectors 124 to the terminals (bond pads 128) of the actuator chip 125 and skilled artisans know various techniques for facilitating this. Also, FIG. 2 shows eight I/O connectors 124, electrical conductors 126 and bond pads 128, for simplicity, but present day printheads have larger quantities and any number is equally embraced herein. The number of connectors, conductors and bond pads, while shown as equal to one another, may also vary unequally in actual embodiments.

At 132, the actuator chip 125 contains at least one ink via that fluidly connects to the ink of the compartment 116. During manufacturing, the actuator chip 125 is attached to the housing with any of a variety of adhesives, epoxies, etc. To eject ink, the actuator chip contains columns (column A-column D) of fluid firing actuators, such as thermal heaters. In other chips, the fluid firing actuators embody piezoelectric elements, MEMs devices, transducers or other. In either, this crowded figure simplifies the actuators as four columns of five dots or darkened circles but in practice might number several dozen, hundred or thousand. Also, vertically adjacent ones of the actuators may or may not have a lateral spacing gap or stagger there between. If practiced, typical actuator pitch spacing includes 1/300^{th}, 1/600^{th}, 1/1200^{th}, or 1/2400^{th} of an inch along the longitudinal extent of a via. Further, individual actuators are formed as a series of thin film layers made via growth, deposition, masking, patterning, photolithography and/or etching or other processing steps on a substrate, such as silicon. A nozzle member with pluralities of nozzle holes, not shown, is adhered to or fabricated as another thin film layer on the actuator chip such that the nozzle holes generally align with and are positioned above the actuators to eject ink.

With reference to FIG. 2, an external device in the form of an inkjet printer contains the printhead 110 during use and is shown generally as 140. It includes a carriage 142 having a plurality of slots 144 for containing one or more printheads 110. The carriage 142 reciprocates (in accordance with an output 159 of a controller 157) along a shaft 148 above a print zone 146 by a motive force supplied to a drive belt 150 as is well known in the art. The reciprocation of the carriage 142 occurs relative to a print medium, such as a sheet of paper 152, which advances in the printer 140 along a paper path from an input tray 154, through the print zone 146, to an output tray 156.

While in the print zone, the carriage 142 reciprocates in a Reciprocating Direction, which is generally perpendicular to an Advance Direction, which is the direction in which the paper 152 is advanced (as shown by the arrows). Ink from compartment 116 (FIG. 1) is caused to eject in a drop(s) from the actuator chip at times pursuant to commands of a printer microprocessor or other controller 157. The timing corresponds to a pattern of pixels of the image being printed. Often times, the patterns are generated in devices electrically connected to the controller 157 (via Ext. input) that reside external to the printer and include, but are not limited to, a computer, a scanner, a camera, a visual display unit, a personal data assistant, or other.

To emit a single drop of ink, an actuator, such as a heater (e.g., one of the dots in columns A-D, FIG. 1), is provided with a small amount of current (such as through a combination, of addressing and pulsing) to rapidly heat a small volume of ink. This causes a portion of the ink to vaporize in a local ink chamber between the heater and the nozzle member, and eject a drop(s) of the ink through a nozzle(s) in the nozzle member toward the print medium. A representative fire pulse used to provide such a current comprises a single or split firing pulse mat is received at the actuator chip on a terminal (e.g., bond pad 128) (or decoded at the heater chip) from connections allocated between the bond pad 128, the electrical conductors 126, the I/O connectors 124 and the controller 157. Internal actuator chip wiring conveys the tire pulse from the input terminal to one or more of many of the actuators.

A control panel 158, having user selection interface 160, also accompanies the printer and serves to provide user input 162 to the controller 157 for additional printer capabilities and robustness.

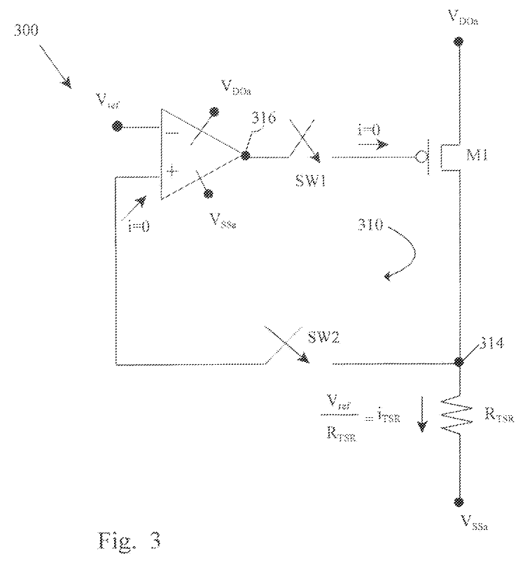

With reference to FIG. 3, a TSR (R_{TSR}) of the actuator chip connects in circuitry 300 of a feedback loop 310 to develop an output current, not voltage, proportional to temperature. In turn, the current is provided to a single I/O terminal (e.g. bond pad—FIG. 1) of the actuator chip for eventual communication to an external device, especially a controller thereof.

In its basic form, the feedback loop comprises an amplifier 312, a transistor M1 and the TSR (R_{TSR}). Representatively, the amplifier is a single-ended operational amplifier well known in the art with inputs consisting of a voltage reference V_{ref}, connecting to the (−) terminal, and a feedback signal, connecting to the (+) terminal, from node 314 between the transistor and the TSR. The behavior of the amplifier is widely understood and is relevant to say it has an open loop gain of greater than about 60 dB, a gain bandwidth greater titan about 100 kilohertz, and a phase margin of greater than about 45 degrees with an intended load. A 5 micro-amp reference current sink to V_{SSa} is applied and set the internal bias currents of the amplifier. On the other side, a supply voltage is applied across the V_{DDa} and V_{SSa} terminals and its voltage, for the sake of discussion, is about 7.5 volts. Switches SW1 and SW2 are also present and are used to cause selection of various TSRs. While the figure only shows a single TSR relating to the basic discussion, more will be added in other embodiments and switching becomes relevant.

During use, the loop operates upon closing the switches SW1 and SW2 and applying the required bias currents and supply voltages. A reference voltage is forced at the V_{ref} input to the amplifier and, for the sake of discussion, is a value of about 1 volt. Vssa, on the other hand, can be essentially thought of as ground. Because the amplifier has a large gain (e.g., >1000) between the difference of the (+) and (−) inputs and its output terminal 316, as the difference increases, the transistor M1 is driven towards high impedance which in turn results in a lower voltage at node 314. As the difference gets smaller, on the other hand, the transistor M1 is driven towards low impedance which results in a higher voltage at the node 314. In essence, the large amplifier gain and the feedback force the amplifier out so that essentially a zero volt difference appears across its input (+) and (−) terminals or equivalently until the node 314 is driven to the V_{ref} potential, in this case about one volt. Also, while the amplifier has second order effects, such as its finite gain and its input offset voltage, a small difference voltage appears across its input (+) and (−) terminals, but for this functional example are small enough to ignore.

With a one volt potential now present at node 314, the current through the TSR (i_{TSR}) is about one volt (or V_{ref}) divided by its resistance (R_{TSR}). Since ideal amplifiers are charged with zero input and output currents, indicated variously by i=0 in the figure, the TSR current also flows through the transistor M1.

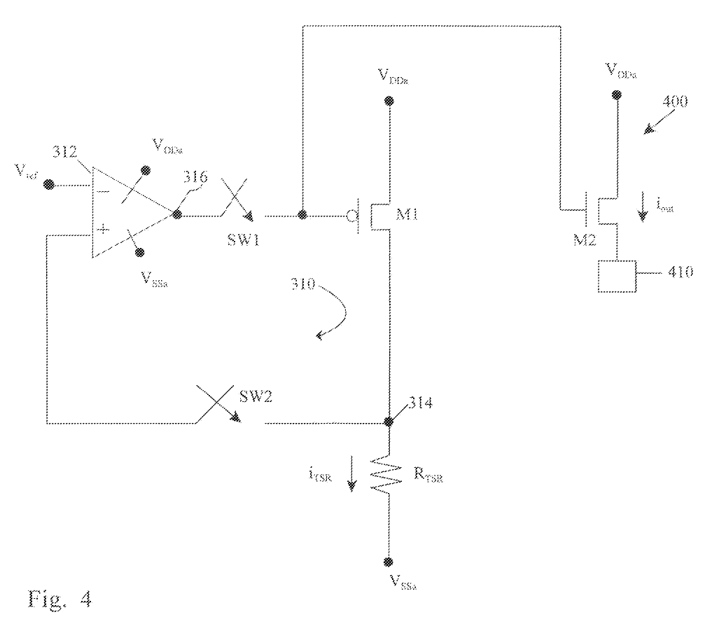

To replicate the current of the TSR at an output terminal of the actuator chip, the notion of a current mirror is added. With reference to FIG. 4, the current mirror 400 connects to the feedback loop (e.g., the gate of transistor M2 connects to the output terminal of the amplifier 316). By doing so, the current of the TSR is now essentially the same as an output current given as iₒᵤₜ and such is provided at a single I/O terminal, especially bond pad 410 (alternatively bond pad 128, FIG. 1). In function, the gate-source voltages of transistors M1 and M2 are identical, and because the transistors are selected to be roughly the same size, the TSR current (i_{TSR}) is mirrored through transistor M2 and delivered on the bond pad 410 as iₒᵤₜ. In other words, iₒᵤₜ=i_{TSR}. During use, as the temperature of the actuator chip changes, the TSR resistance (R_{TSR}) changes but the voltage remains the same at Vref, or about 1 volt. This causes the output current at iₒᵤₜ to be defined as:

$$i out = \frac{V ref}{R ( T )} where R ( T ) = {R}_{25 C} \times [ 1 + ( T - 25 ) \times 2075 e - 6 ]$$

and where T is in degrees Celsius and Vref=1 volt; R(T) also equals R_{TSR}. Advantageously, such an embodiment advances the art because a single-point, current output representation of temperature is given.

In an alternate embodiment, it may be desirable to alter transistor M2 such that iₒᵤₜ=i_{TSR}×a scaling factor, where the scaling factor gains up the current on-chip, but not the noise. In this manner, a greater signal-to-noise ratio for the output signal (iₒᵤₜ) is achieved and such provides greater measurement accuracy over prior art two-pin voltage TSR outputs. In one instance, transistor M2 (representatively a PMOS transistor) is scaled using multiple MOS devices of the same size to gain scale the output by ratios of amounts of 2, 4, or 8. It is noted, however, that using an integer number of devices (MOS) makes the gain precise because the MOS transistors typically mismatch to an error of less than 1%.

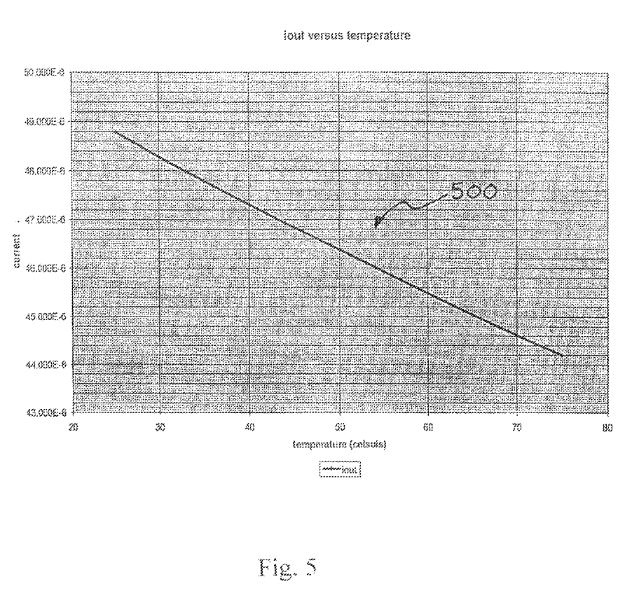

In FIG. 5, a representative relationship between the output current (iₒᵤₜ) and the temperature sensed by the TSR is given as 500. As is seen, an essentially linear relationship is obtained between the current and temperature and such occurs with decreasing current per increasing temperature.

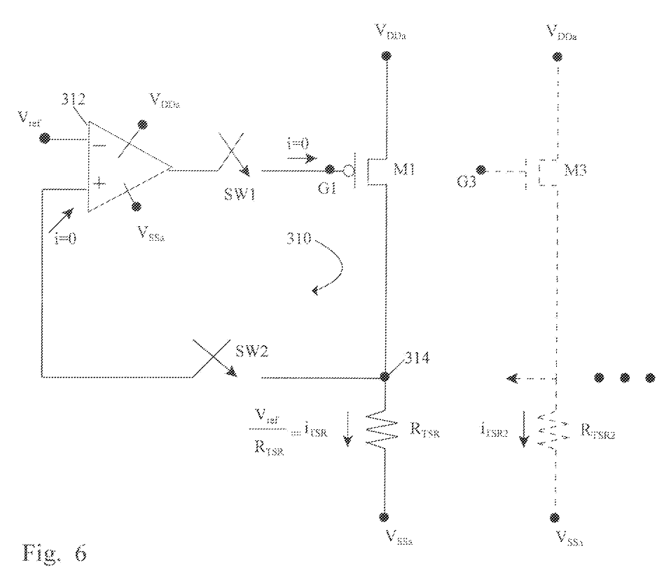

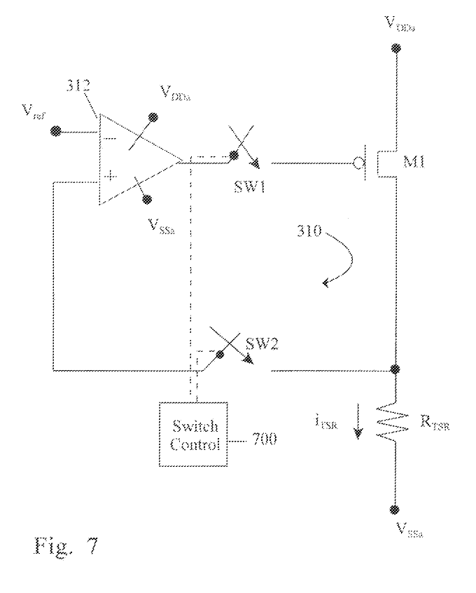

With reference to FIGS. 6 and 7, it is seen that other TSRs (R_{TSR2}) can be cascaded together so that multiple TSRs can be given per a single actuator chip. In order to determine whether the output current (iₒᵤₜ) corresponds to the first, second or other TSR current, skilled artisans will coordinate the operation of the switches SW1 and SW2. In this regard, FIG. 7 shows a switch control 700. Later figures will also show this as actual transistor components. To actually select the second or other TSR in favor of the first-described TSR, the gate G1 is driven to turn off transistor M1 while the gate G3 is driven to turn on transistor M3. In this case, the first TSR is now out of the feedback loop 310 while the second TSR (R_{TSR2}) is connected in the feedback loop. In turn, its resistance (R_{TSR2}) now causes the output current (iₒᵤₜ) at the terminal to be that of i_{TSR2}. Naturally, the current mirror of FIG. 4 is used to accomplish this. The output current corresponding to the second TSR may also be a scaled version of the current in the second TSR. To add still other TSRs to the feedback loop, resistor and transistor elements are added in the manner shown for the second TSR. Selecting these other TSRs occurs by coordinating the switches.

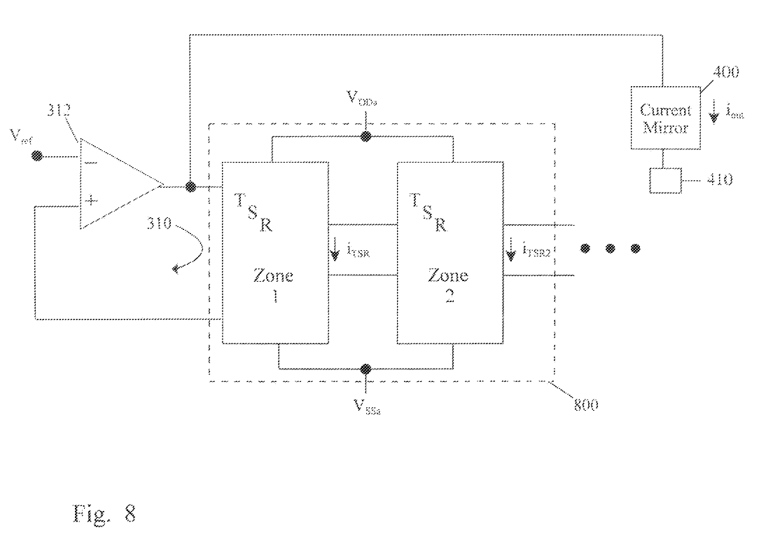

With reference to FIG. 8, and continued reference to prior FIGS. 5, 6 and 7, another feature of an exemplary embodiment of the invention, is that of chip current averaging. For simplicity, the transistors and TSRs (e.g., M1 and R_{TSR}; and M3 and R_{TSR2}) are given in the feedback loop 310 as groups per a zone 1 or zone 2 of the actuator chip and they representatively sense temperature in a pre-selected zone of the chip. Also, this chip averaging feature is maintained while still providing an actuator chip with one or more TSRs and a single-point, current-based output (iₒᵤₜ) at 410. For example, consider the case when both transistors M1 and M3 are caused to conduct, thereby causing both TSRs to exist in the feedback loop 310. Each then has a V_{ref} or about, a 1 volt potential and a current (i_{TSR} and i_{TSR2}) flowing therein. With the transistors M1 and M3 selected to be a same size, especially PMOS transistors, each has roughly the same gate-source voltage. Equivalently (800), they then correspond to a single PMOS transistor that is twice the size of the individual transistors M1 and M3 and a current is the sum of both their currents (i_{TSR}+i_{TSR2}). In turn, the relative size of the current mirror 400 is now one half what it was when a single transistor and single TSR were in the feedback loop 310. Therefore, the current mirror is one half of the equivalent combined transistor of M1 and M3 and has the sum of the currents of the TSRs flowing through it. This then averages the currents flowing through both TSR elements. In certain applications, such as where individual TSRs are used in small chip regions, the output can either be individually sensed or averaged to a single value. Further embodiments similarly follow this relationship, such as when adding any number of TSR elements (given as ellipses).

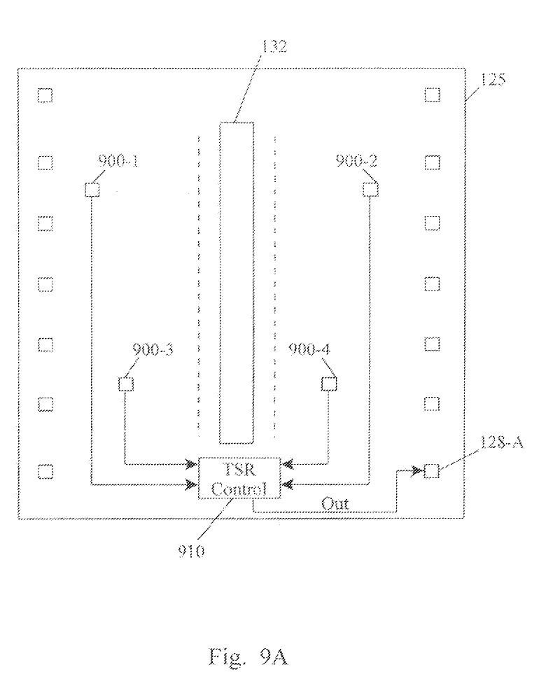

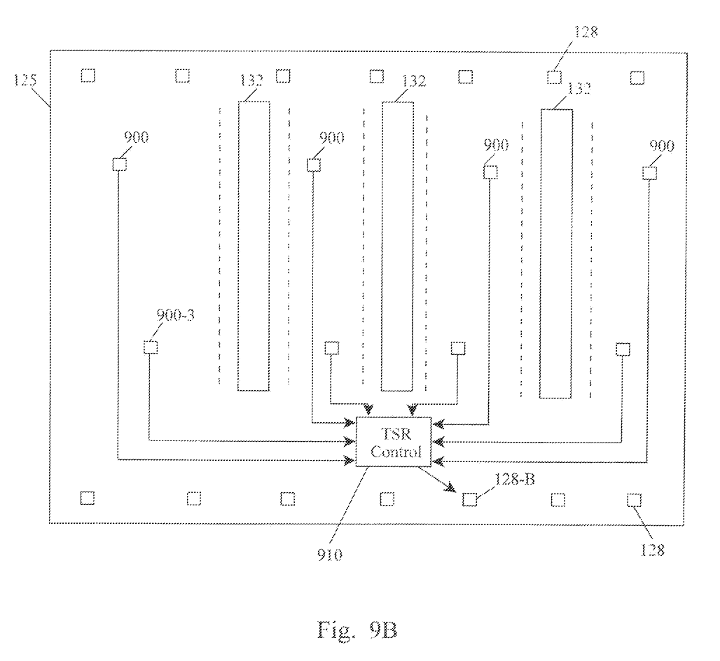

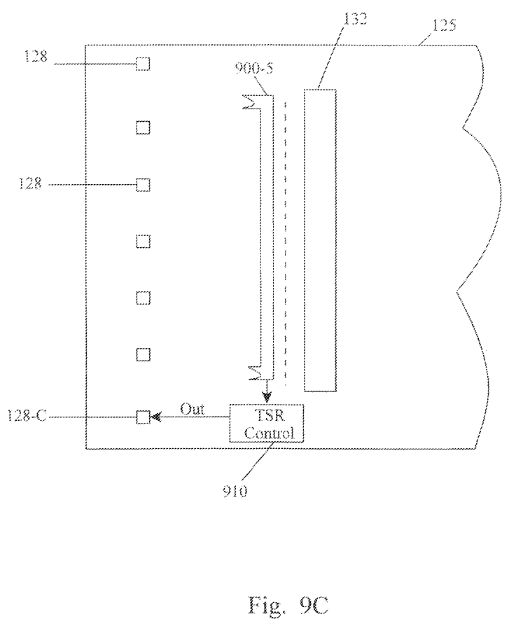

With reference to FIGS. 9A-9C, a single actuator chip may be divided into varieties of zones with a TSR per zone to give decent actuator chip temperature averaging. That is, an actuator chip 125 includes pluralities of I/O terminals in the form of bond pads 128. One or more ink vias 132 are formed in the chip and include multiple ink actuators (again, in the form of darkened circles, or dots). The bond pads also align in generally parallel columns with the longitudinal extent of the vias or transverse thereto. The TSRs 900 are found distributed throughout the chip relative to the ink actuators for sensing temperature in nearby vicinities. They are also given as relative point sources of temperature, e.g., TSRs 900-1 through 900-4 or as a large collection of temperature, e.g., TSR 900-5. Regardless, a TSR control circuit 910, such as the previously described feedback loop 310, communicates individually or collectively with the TSRs 900 and a current-based, single output 128-A, 128-B or 128-C of the chip is given. Heretofore, this could never occur with voltage-based outputs.

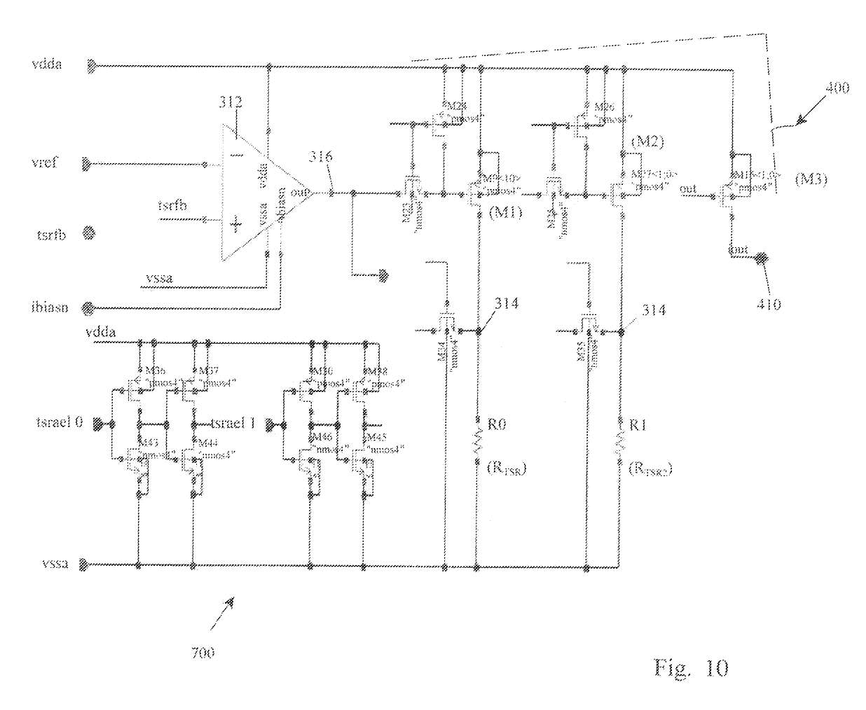

With reference to FIG. 10, a representative actual circuit contemplative of the foregoing concepts is illustrated with actual circuit components. In parenthesis, certain of the foregoing basic components are given. Ultimately, a single, current output iₒᵤₜ is given at 410 for the representative TSRs (R_{TSR} and R_{TSR2}).

Additionally, the foregoing illustrative examples contemplated a low side potential reference of V_{SSa} of about zero volts. In alternative applications, however, where the low side reference for the TSR needs to be greater than zero, such can be accommodated by simply forcing the low side potential to a higher value and adding the equivalent voltage to the voltage forced at V_{ref}. In instances with prior art TSR devices having n-type diffusion resistors that require a reverse body bias to minimize the voltage dependent diffusion capacitance, this is particularly advantageous.

Regarding V_{ref}, the foregoing contemplated a voltage which is either internally (on-chip) or externally (off-chip) generated. Also, as more TSR elements are added, e.g. FIG. 6, only the internal logic signals to select the added TSR are required. The size of the selection switches is better if left small, because any errors they add are cancelled by the feedback loop. It is also a good design point to size current mirror devices M24, M26 and M16, e.g., FIG. 10, to have good matching characteristics to insure accurate mirror behavior. This can also be done with a total device area that is smaller than prior art 500 micrometer devices.

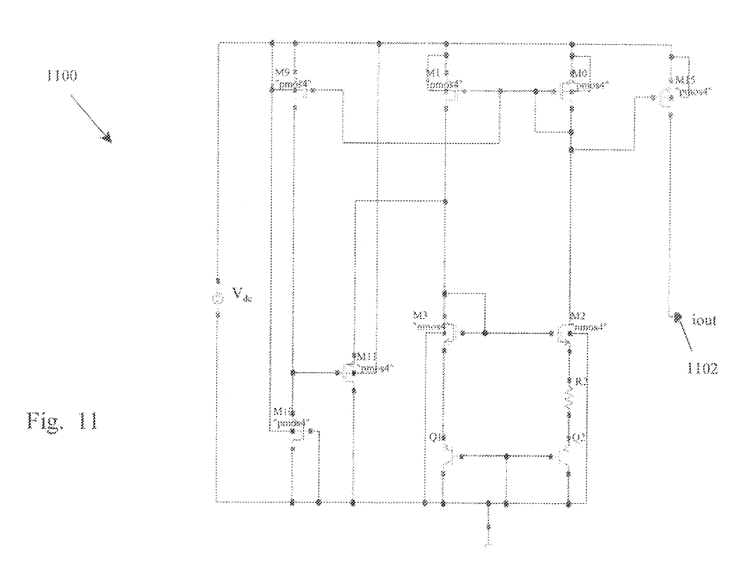

With reference to FIG. 11, an alternate embodiment of an actuator chip having multiple TSRs with a current, single-point output 1102 is given as 1100. While the values of the components on the schematic are shown, they are not material to the description and are included for graphical reference only. Also, bipolar transistors have Q# designations and MOS transistors have M# designations. Power for the circuit 1100 is applied via voltage source V0. The temperature sensor elements are Q1, Q2 and R2. The transistor Q1 is a single substrate bipolar PNP transistor while Q2 is composed of eight transistors identical to Q1 connected in parallel thereby making Q2 eight times the size of Q1. The emitter of Q1 is connected to the source of M3 while the base and collector are connected to the substrate connection which is connected to ground during the CMOS process. The emitter of Q2 is connected to a resistor R2 that is connected to the source of M2. The base and collector of Q2 are also connected to ground. Naturally, the basic relationship between a PNP transistor's emitter current and its base-emitter voltage (Vbe) is:

Ie=Is×area×exp(Vbe/(kT/q));

where Is and area are constants for a device; k=1.38e−23 (Boltzman's constant); q=1.6e−1.9 (charge of an electron); and T=temperature in Kelvin.

Transistors M1 and M0 form a PMOS device current mirror where the drain currents of both devices are equal because they are the same size and their gate-source voltages are equal. Similarly, transistors M3 and M2 are identically sized devices forming an NMOS current mirror where the drain currents are both equal causing their gate-source voltages to also be equal. Since the drain currents of M2 and M3 are equal, then the emitter currents of Q1 and Q2 are equal. However, because they have different sizes or, more precisely, different areas, the base-emitter voltages will be different. Finally, because M2 and M3 are identically sized devices and their drain currents are equal, the difference in the Q1 and Q2 base-emitter voltages appears across the R2 resistor. This sets the temperature dependent current that flows thru M0, M1, M2, and M3 by the relation:

$$I ( T ) = \frac{kT}{Rq} \cdot ln ( \frac{areapnp 2}{areapnp 1} ) ; where R = R 2 resistance .$$

Further, the resistor R2 is made of a resistor material that is chosen to have a relative small temperature coefficient, such as on the order of about −120 PPM. The delta-Vbe voltage has a temperature coefficient of approximately 3300 PPM per degree Celsius so this has only a minor effect on the slope. The temperature dependent current is then mirrored to an output device M15. As before, it is to be noted that gain can be added by simply sizing M15 to be a multiple of size of M0 such as 2, 4 or 8. Transistors M9, M10 and M11 form a startup network to insure that the circuit settles to a defined output value. It is necessary because there is another stable state that exists for the delta-Vbe circuit where no current is flowing in any branch.

While delta-Vbe circuits are known in the art, this exemplary embodiment of the invention differs from other applications because an output current 1102 is generated that is PTAT (Proportional to Absolute Temperature) rather than an output voltage, as before.

The output current has a slope of approximately 3300 ppm per degree Celsius which is approximately 60% greater than the 2075 ppm per degree Celsius of the prior art TSRs. This gives the delta-Vbe sensor an advantage in that it is has a greater dynamic range of it output relative to the TSR. The current gain may be applied on-chip which increases the signal to noise ratio of the current signal before it is delivered to the external circuit. The circuit can be made very small which allows for its use in additional applications where the large TSR would be unsuitable. For example, because of its small size the current sensed is more like a point source measurement than the average die temperature sensed by the TSR. A point source measurement may be more useful in some applications and a number of point source measurement devices can simply be ganged together and summed to form an average measurement.

For calibration, the delta-Vbe current may be calibrated by using an ambient temperature sensor available on the carrier to make a reference temperature measurement that correlates the sensor's resulting voltage at a known temperature. Naturally, the slope of the delta-Vbe current generator is inversely proportional to die value of the resistance that the delta-Vbe voltage appears across, which in this case is made of the same material as the ink actuator material, e.g., tantalum. Since the tolerance of this resistance is well controlled in the backend process, its variation may be removed by measuring the sensor current value at a known temperature. The variation from the nominal current value is determined to the first order by the resistance of the ink actuator material. Since the resistance is inversely proportional to the sensor's current versus temperature slope, the resistance variation error factor may be removed by using the nominal current measurement to calculate a slope correction multiplier. Since the output current goes through one or more current mirrors before it exits the actuator chip at a single output, more elegant calibration methods are also possible. For instance, if the actuator chip has a non-volatile memory it is possible to measure the output current at a wafer probe to determine its variation from the nominal value. Then, by using a small array of fractional current scaling MOS transistors, the current may be scaled to the correct value. The fractional sealing value for the MOS transistor array could be stored and retrieved from the non-volatile memory in such a way that the scale factor would always be corrected whenever inkjet printheads are initialized.

Finally, the foregoing description is presented for purposes of illustration and description of the various aspects of the invention. The descriptions are not intended, however, to be exhaustive or to limit the invention to the precise form disclosed. Accordingly, the embodiments described above were chosen to provide the best illustration of the principles of the invention and its practical application to thereby enable one of ordinary skill in the art to utilize the invention in various embodiments and with various modifications, such as combinations of the foregoing, as are suited to the particular use contemplated. All such modifications and variations are within the scope of the invention as determined by the appended claims when interpreted in accordance with the breadth to which they are fairly, legally and equitably entitled.

What is claimed:

1. An inkjet printhead actuator chip, comprising:
a temperature sense resistor with an output provided as a current.

2. The actuator chip of claim 1, wherein the temperature sense resistor connects in a feedback loop circuit.

3. The actuator chip of claim 1, further including multiple temperature sense resistors cascaded together.

4. The actuator chip of claim 1, wherein the output is provided on a single of multiple bond pads.

5. An inkjet printhead actuator chip, comprising:
a plurality of bond pads; and
a temperature sense resistor having an output, the output connected to only a single one of the plurality of bond pads.

6. The actuator chip of claim 5, wherein the output is provided as a current proportional to temperature.

7. The actuator chip of claim 5, further including multiple temperature sense resistors each with a respective output, the respective outputs connected to the single one of the plurality of bond pads.

8. The actuator chip of claim 7, wherein the multiple temperature sense resistors connect in a circuit to average temperatures per a plurality of temperature zones.

9. An inkjet printhead actuator chip, comprising:
a plurality of bond pads;
a plurality of temperature sense resistors each having an output provided as a current proportional to temperature in a nearby vicinity, the outputs connected to only a single one of the plurality of bond pads.

10. The actuator chip of claim 9, further including circuitry to apply scaling and gain to the outputs.

11. The actuator chip of claim 9, wherein the plurality of temperature sense resistors connect in a feedback loop circuit.

12. The actuator chip of claim 11, further including a plurality of drive transistors per the each of the plurality of temperature sense resistors.

13. The actuator chip of claim 11, wherein the each of the plurality of temperature sense resistors are selected from materials such that as temperature rises, the resistance of the each of the plurality of temperature sense resistors decrease thereby decreasing the current of the output provided in proportion to the temperature.

14. An inkjet printhead, comprising:
an actuator chip for delivering ink from the printhead, the actuator chip having a plurality of bond pads for electrically connecting to a controller of an external device;
a plurality of temperature sense resistors of the actuator chip each having an output provided as a current proportional to temperature in a nearby vicinity, the outputs connected to only a single one of the plurality of bond pads; and
circuitry for scaling the outputs on the actuator chip to avoid scaling at the controller of the external device.

15. The inkjet printhead of claim 14, further including one or more current mirrors of the actuator chip associated with the plurality of temperature sense resistors.

16. The inkjet printhead of claim 14, wherein the plurality of temperature sense resistors connect in a feedback loop circuit of the actuator chip.

17. The inkjet printhead of claim 14, further including circuitry of the actuator chip for averaging temperature per a plurality of temperature zones on the actuator chip.

18. The inkjet printhead of claim 14, wherein each of the plurality of temperature sense resistors have a size serving as point sources of temperature.

19. The inkjet printhead of claim 14, wherein each of the plurality of temperature sense resistors are arranged per ink vias of the actuator chip.
